(19) United States
(12) Patent Application Publication
(10) Pub. No.: US 2026/0236931 A1
(43) Pub. Date: Aug. 13, 2026

(54) MODULAR AND CENTRALIZED MULTI-APPLICATION TRANSACTION RESTRICTION FRAMEWORK

(71) Applicants: Joshua D. Cohen, West Hartford, CT (US); Chandra Bhat, Rocky Hill, CT (US); Seshaphani Chakka, Charlotte, NC (US); Saleh Ahmed Alsubai, West Hartford, CT (US)

(72) Inventors: Joshua D. Cohen, West Hartford, CT (US); Chandra Bhat, Rocky Hill, CT (US); Seshaphani Chakka, Charlotte, NC (US); Saleh Ahmed Alsubai, West Hartford, CT (US)

(21) Appl. No.: 19/051,599

(22) Filed: Feb. 12, 2025

(51) Int. Cl. G06Q 20/40; G06F 9/54

(52) U.S. Cl. CPC G06Q 20/405; G06F 9/54; G06Q 20/407

(57) ABSTRACT

A transaction restriction framework for an enterprise may include a configuration data store with electronic records associated with enterprise applications including, for each application, at least one application identifier and associated transaction restriction. A transaction restriction tool, coupled to the configuration data store, may receive a transaction check request, including an application identifier and a transaction identifier, from a consuming application via API. The transaction restriction tool can then access the configuration data store to determine a transaction restriction associated with the consuming application. A transaction check can then be automatically performed based on the transaction restriction and transaction identifier, and the transaction restriction tool may transmit a response to the consuming application indicating a result of the transaction check.

### TECHNICAL FIELD

The present application generally relates to computer systems and more particularly to computer systems that are adapted to accurately, securely, and/or automatically support a transaction restriction framework for an enterprise.

### BACKGROUND

An enterprise may interact with clients (e.g., potential customers) through various applications. For example, an application might calculate and provide a customized price quote for goods or services. As another example, an application might let a customer search an enterprise database looking for specific information (e.g., a product manual).

In some cases, however, a malicious actor may inappropriately interact with an enterprise application. For example, they might flood the application with requests looking to slow down or disable the system. As another example, they may repeatedly submit price quote requests in an attempt to determine a proprietary pricing algorithm. To prevent such abuses, application developers may implement appropriate mechanisms to detect and prevent repeated requests from actors. Typically, application developers write this logic for each application where they need to implement restrictions (e.g., to block quote transaction if more than ten quotes are created from the same communication address in a single day or block customer searches if more than five searches are done by the same user in an hour). It can be very difficult, however, to meet these objectives when creating an enterprise application. For example, it might be especially time-consuming and costly when there are a substantial number of applications, many different types of restrictions, etc. that need to be supported. It would be desirable to provide improved systems and methods to accurately and/or automatically support a transaction restriction framework for an enterprise. Moreover, the results should be easy to access, understand, interpret, update, etc.

### SUMMARY OF THE INVENTION

According to some embodiments, systems, methods, apparatus, computer program code and means are provided to accurately and/or automatically support a transaction restriction framework for an enterprise in a way that provides fast, secure, and useful results and that allows for flexibility and effectiveness when responding to those results.

Some embodiments are directed to a transaction restriction framework for an enterprise with a configuration data store that contains electronic records associated with enterprise applications including, for each application, at least one application identifier and associated transaction restriction. A transaction restriction tool, coupled to the configuration data store, may receive a transaction check request, including an application identifier and a transaction identifier, from a consuming application via API. The transaction restriction tool can then access the configuration data store to determine a transaction restriction associated with the consuming application. A transaction check can then be automatically performed based on the transaction restriction and transaction identifier, and the transaction restriction tool may transmit a response to the consuming application indicating a result of the transaction check.

Some embodiments comprise: means for receiving, by a back-end application computer server associated with a transaction restriction tool, a transaction check request, including an application identifier and a transaction identifier, from a consuming application of the enterprise via an API; means for accessing a configuration data store to determine a transaction restriction associated with the consuming application, wherein the configuration data store contains electronic records associated with enterprise applications including, for each application, at least one application identifier and associated transaction restriction; means for automatically performing a transaction check based on the transaction restriction and transaction identifier; and means for transmitting a response to the consuming application indicating a result of the transaction check.

In some embodiments, a communication device associated with a back-end application computer server exchanges information with remote devices in connection with interactive graphical user interfaces. The information may be exchanged, for example, via public and/or proprietary communication networks.

A technical effect of some embodiments of the invention is improved and computerized support of transaction restrictions that provides fast, secure, and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of an enterprise system in accordance with some embodiments.

FIG. 2 is a transaction restriction method according to some embodiments.

FIG. 3 is a transaction system API architecture in accordance with some embodiments.

FIG. 4 is a configuration flow architecture according to some embodiments.

FIG. 5 is a configuration flow request and potential responses in accordance with some embodiments.

FIG. 6 is a configuration table according to some embodiments.

FIG. 7 is a transaction request check flow architecture in accordance with some embodiments.

FIG. 8 is a transaction check request and potential responses according to some embodiments.

FIG. 9 is a transaction table in accordance with some embodiments.

FIG. 10 is a configuration flow according to some embodiments.

FIGS. 11 through 13 are a transaction check request flow in accordance with some embodiments.

FIG. 14 illustrates relationships between tables according to some embodiments.

FIG. 15 is a configuration table design in accordance with some embodiments.

FIG. 16 shows transaction table details according to some embodiments.

FIG. 17 shows blocked transaction table details in accordance with some embodiments.

FIG. 18 is a transaction restriction cloud architecture according to some embodiments.

FIG. 19 is a block diagram of an apparatus in accordance with some embodiments.

FIG. 20 is a portion of a configuration database according to some embodiments.

FIG. 21 is a tablet computer according to some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data processing associated with a transaction restriction framework. The present invention is directed to more than merely a computer implementation of a routine or conventional activity previously known in the industry as it provides a specific advancement in the area of transaction restrictions by providing improvements in the operation of a computer system that automatically implements appropriate transaction restriction configurations for applications. The present invention provides improvement beyond a mere generic computer implementation as it involves the novel ordered combination of system elements and processes to provide improvements in the speed, security, and accuracy of such a transaction restriction tool for an enterprise. Some embodiments of the present invention are directed to a system adapted to automatically handle third-party data, aggregate information from multiple data sources, automatically respond to API requests in a way that reduces unnecessary messages or communications, etc. (e.g., to consolidate communications between parties within an enterprise). Moreover, communication links and messages may be automatically established, aggregated, formatted, modified, removed, exchanged, etc. to improve network performance (e.g., by reducing an amount of network messaging bandwidth and/or storage required to create allocation workflows or alerts, improve security, reduce the size of data stores, more efficiently collect, present, and utilize transaction restriction information and results, etc.).

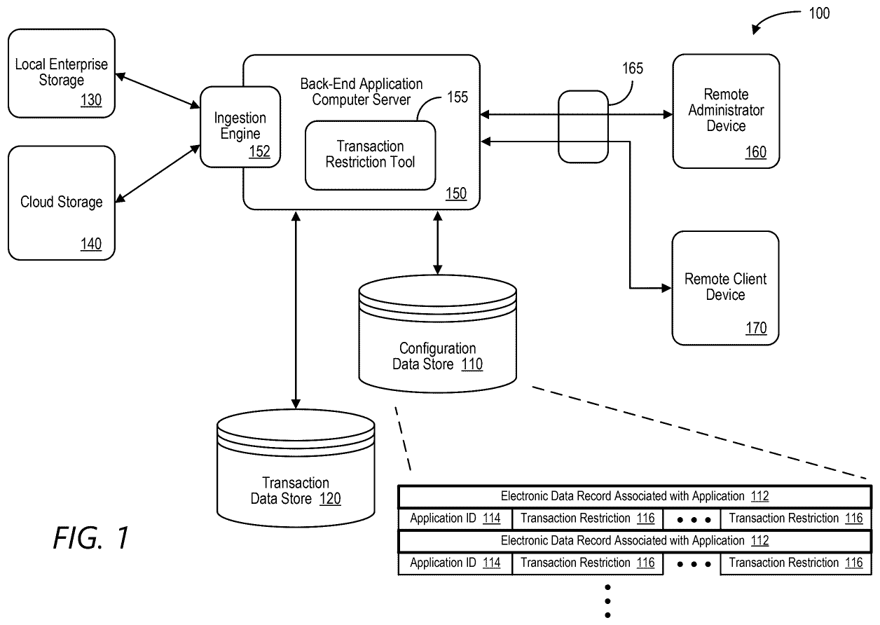

FIG. 1 is a high-level block diagram of an enterprise system 100 that may be provided according to some embodiments of the present invention. In particular, the system 100 includes a back-end application computer server 150 that may access information in a configuration data store 110 (e.g., storing a set of electronic records associated with applications 112, each record including, for example, one or more application identifiers 114 and transaction restrictions 116, etc.). The back-end application computer server 150 may also store information into other data stores, such as a transaction store 120, and utilize an ingestion engine 152 and a transaction restriction tool 155 to exchange and process messages and view, analyze, and/or update electronic records. The back-end application computer server 150 may also exchange information with a remote administrator device 160 and a remote client device 170 (e.g., via a firewall 165). According to some embodiments, an interactive graphical user interface platform of the back-end application computer server 150 may facilitate the creation and review of transaction restriction information, recommendations, alerts, and/or the display of results via one or more remote administrator computers (e.g., to summarize system 100 performance) and/or the remote client devices 170. For example, the remote administrator device 160 may transmit annotated and/or updated information to the back-end application computer server 150. Based on the updated information, the back-end application computer server 150 may adjust data in the configuration data store 110 and the changes may (or may not) be used in connection with the remote client device 170.

Note that the back-end application computer server 150 and/or any of the other devices and methods described herein might be associated with a third party, such as a vendor that performs a service for an enterprise. The back-end application computer server 150 and/or the other elements of the system 100 might be, for example, associated with a Personal Computer (“PC”), laptop computer, smartphone, an enterprise server, a server farm, and/or a database or similar storage devices. According to some embodiments, an “automated” back-end application computer server 150 (and/or other elements of the system 100) may facilitate the automated access and/or update of electronic records in the data stores 110, 120 and/or the automated management of transaction restrictions. As used herein, the term “automated” may refer to, for example, actions that can be performed with little (or no) intervention by a human.

Devices, including those associated with the back-end application computer server 150 and any other apparatus described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the configuration data store 110, the transaction store 120, local enterprise storage 130, cloud storage 140, etc. The data stores 110, 120 may be locally stored or reside remote from the back-end application computer server 150. As will be described further below, the configuration data store 110 may be used by the back-end application computer server 150 in connection with an interactive user interface to facilitate transaction restrictions for an enterprise. Although a single back-end application computer server 150 is shown in FIG. 1, any number of such devices may be included. Moreover, various devices described herein might be combined according to embodiments of the present invention. For example, in some embodiments, the back-end application computer server 150 and configuration data store 110 might be co-located and/or may comprise a single apparatus.

The elements of the system 100 may work together to perform the various embodiments of the present invention. Note that the system 100 of FIG. 1 is provided only as an example, and embodiments may be associated with additional elements or components. According to some embodiments, the elements of the system 100 automatically transmit information associated with an interactive user interface display over a distributed communication network.

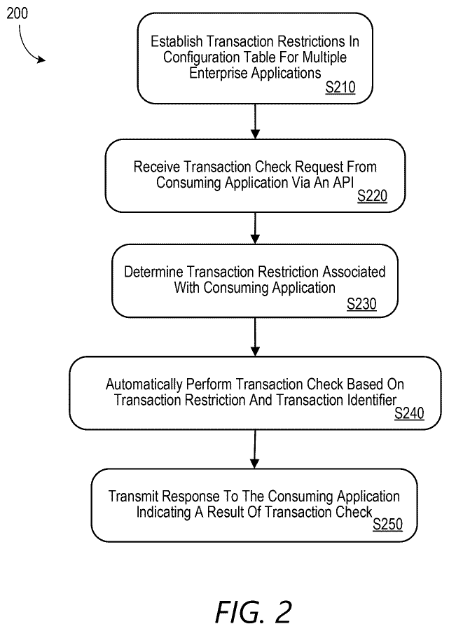

FIG. 2 is a transaction restriction method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, transaction restrictions are established in a configuration table for multiple enterprise applications. For example, a configuration request received from an administrator might include an application identifier, a transaction type, a transaction identifier type, a time duration type, a time duration, a threshold, a block period type, a block period, a “disable” flag, a “requested by” identifier, an action, etc. Moreover, a response to the configuration request may include a “success” status, an “error” status, and a message explaining the status. In some embodiments, the transaction restriction tool is able to configure a time duration in accordance with minutes, hours, calendar days, business days, etc.

At S220, a back-end application computer server associated with a transaction restriction tool receives a transaction check request, including an application identifier and a transaction identifier (e.g., a communication address, an IP address, a user identifier, a state, a session identifier, etc.), from a consuming application of the enterprise via an API. According to some embodiments, the transaction check request further includes a transaction type and/or a transaction identifier type.

At S230, the transaction restriction tool may access the configuration data store to determine a transaction restriction associated with the consuming application. The transaction restriction might, for example, prevent more than a threshold number of transactions from a communication address, prevent more than a threshold number of transactions from a communication address within a predetermined period of time, prevent more than a threshold number of transactions from a communication address from a particular user, etc.

At S240, a transaction check is automatically performed based on the transaction restriction and transaction identifier. At S250, the transaction restriction tool may transmit a response to the consuming application indicating a result of the transaction check. The result of the transaction check might, for example, indicate that the transaction is “allowed” when a number of transactions is within a threshold limit in a given time duration. As another example, the result of the transaction check might indicate that the transaction is “not allowed” when a number of transactions exceeds a threshold limit and no blocking period is set. In some embodiments, the result of the transaction check indicates that the transaction is “blocked” when a number of transactions exceeds a threshold within a blocking period.

In some embodiments, the transaction restriction tool is able to enable or disable transaction checks for specific configurations. Moreover, the transaction restriction tool may be able to whitelist transactions (e.g., to test the tool) and/or capture an incoming request from the consuming application in one place and perform the transaction request check in another place or do both at same time.

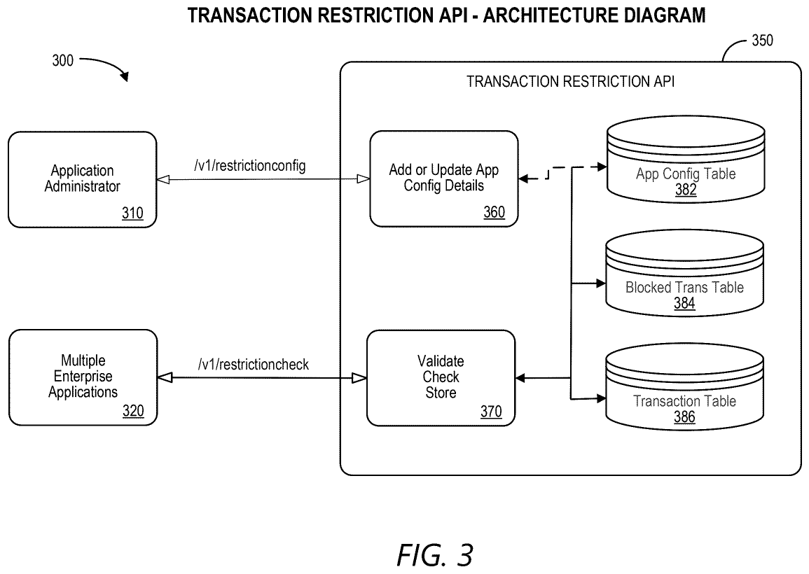

FIG. 3 is a transaction system API architecture 300 in accordance with some embodiments. An application administrator 310 or operator may exchange information with a transaction restriction API 350 to add or update configuration details 360 in an application configuration table 382. The transaction restriction API 350 may comprise a Representational State Transfer (“REST”) API that can be consumed by any application within an enterprise. The API 350 has a separate configuration table 382 where application specific thresholds can be configured and modified based on need. A REST end point (“/v1/restrictionconfig”) may be exposed to consumer application teams to add or modify configuration details.

Multiple enterprise applications 320 exchange information with the transaction restriction API 350 to perform a validate check store 370 to be recorded in a blocked transaction table 384 and/or a transaction table 386. The API 350 has a separate transaction table 386 to store the incoming request received from a consumer application and uses the same to make the decision. A new REST end point (“/v1/restrictioncheck”) may be exposed to consumer application teams to get the decision.

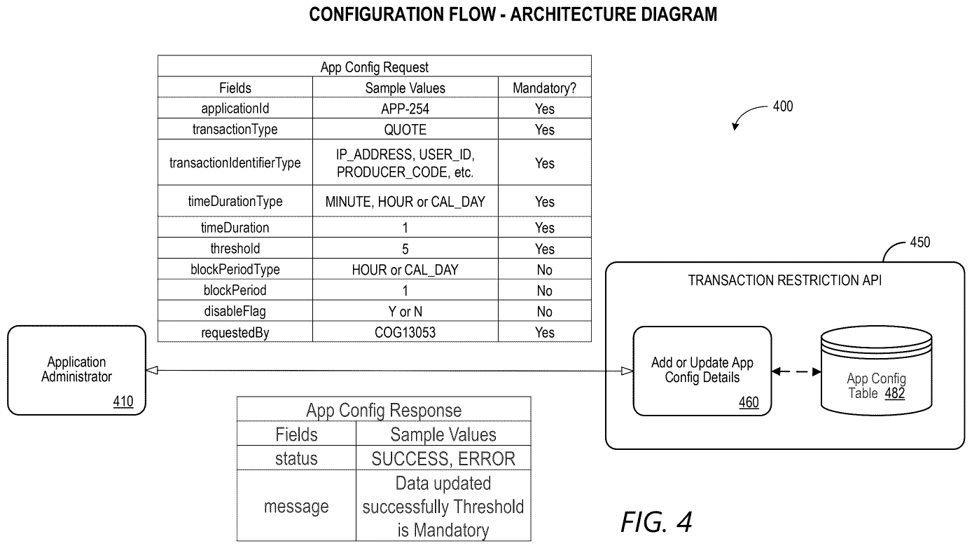

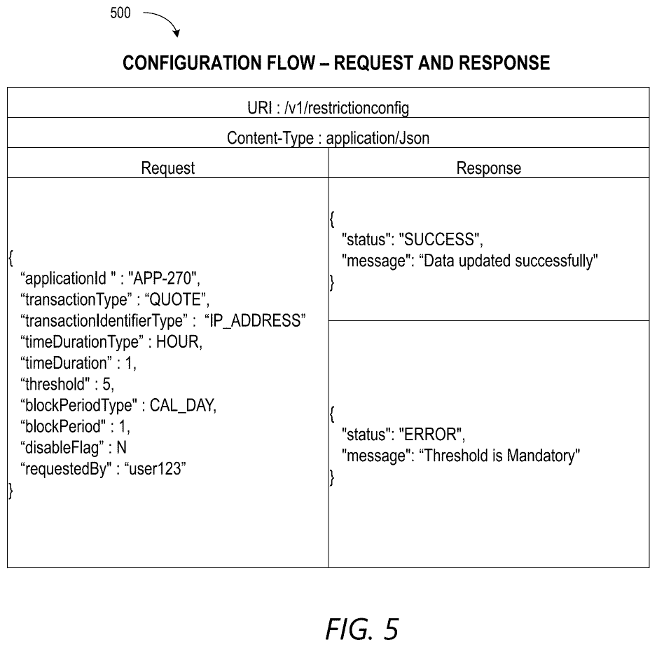

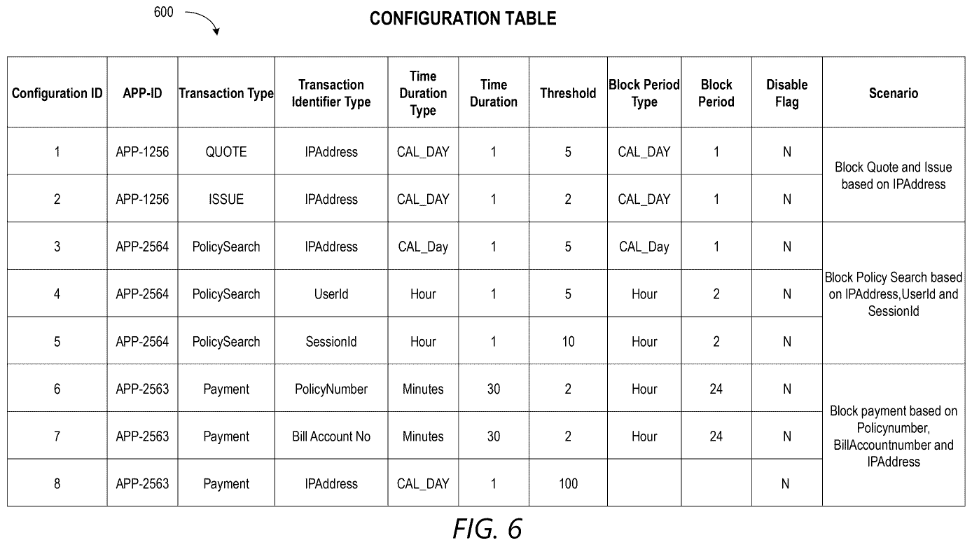

FIG. 4 is a configuration flow architecture 400 according to some embodiments. An application administrator 410 or operator may transmit an application configuration request to a transaction restriction API 450 to add or update configuration details 460 in an application configuration table 482. The application configuration request might specify an application identifier, a transaction type, a transaction identifier type, a time duration type, a time duration, a threshold, a block period type, a block period, and a “disable” flag. The Transaction Restriction API 450 responds with an application configuration that includes a status (update was a “success” or “error”) and a message providing a reason for the status. FIG. 5 is a configuration flow request and potential responses 500 (e.g., JavaScript Object Notation (“JSON”) content) in accordance with some embodiments. FIG. 6 is a configuration table 600 according to some embodiments. The configuration table 600 defines transaction restrictions for multiple enterprise applications.

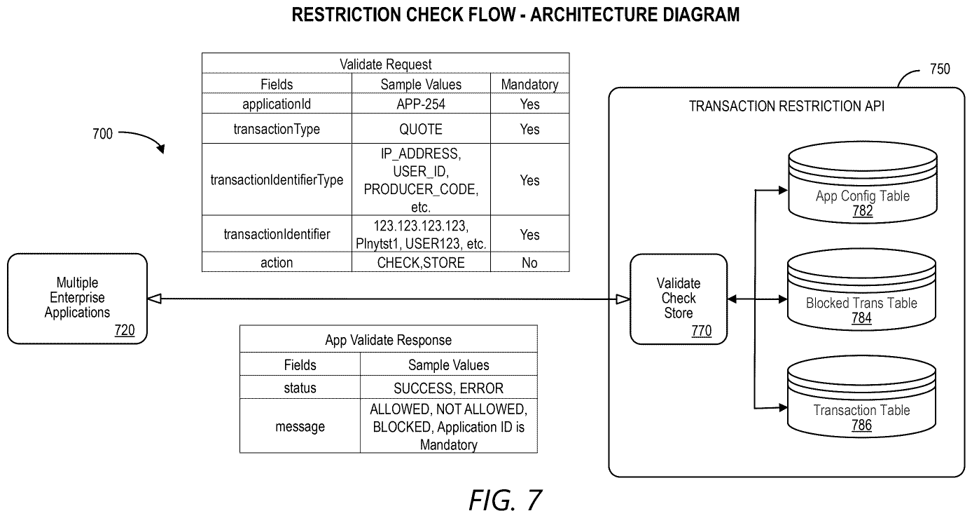

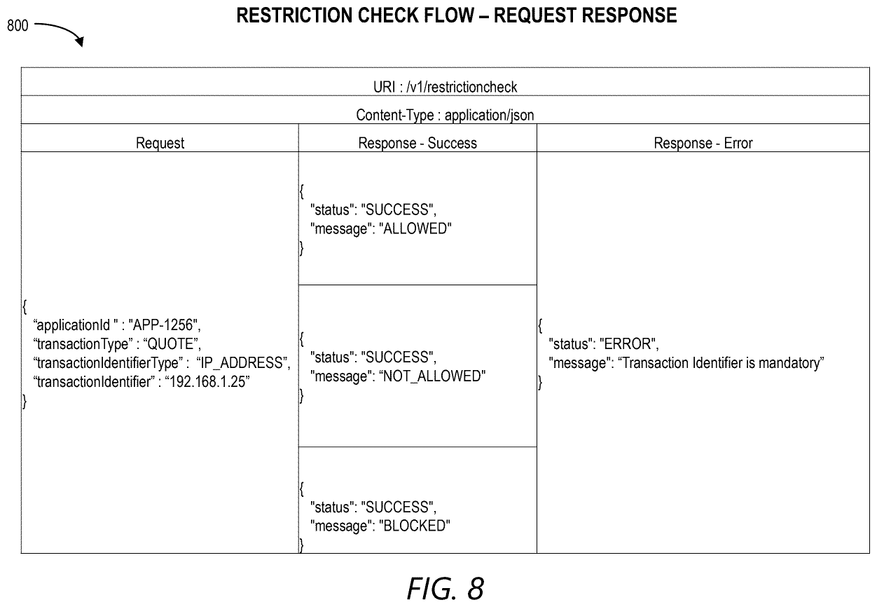

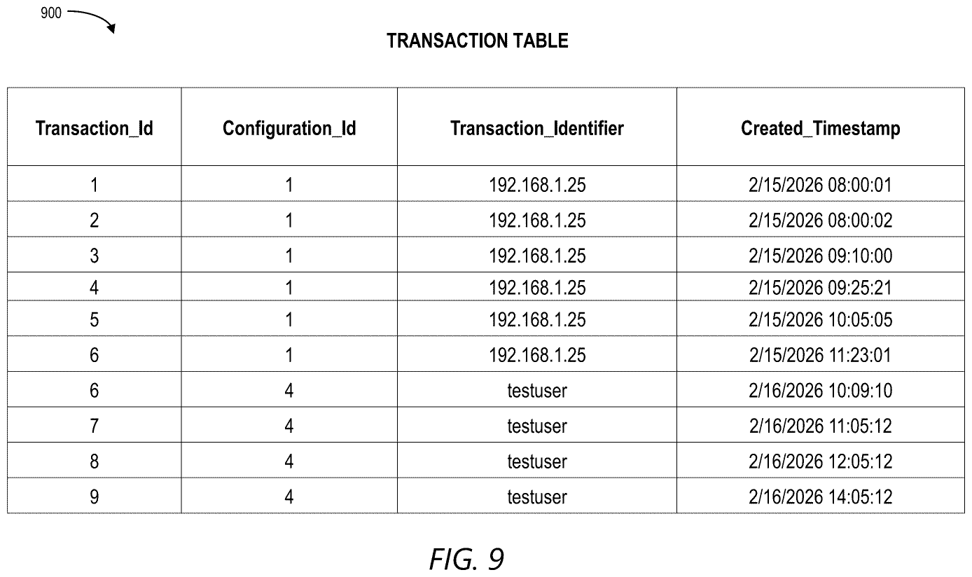

FIG. 7 is a transaction request check flow architecture 700 in accordance with some embodiments. Multiple enterprise applications 720 exchange information with the transaction restriction API 750 to perform a validate check store 770 to be recorded in a blocked transaction table 784 and/or a transaction table 786 based on information in an application configuration table 782. The API 750 has a separate transaction table 786 to store the incoming request received from a consumer application. FIG. 8 is a transaction check request and potential responses 800 (e.g., JSON content) according to some embodiments. FIG. 9 is a transaction table 900 in accordance with some embodiments.

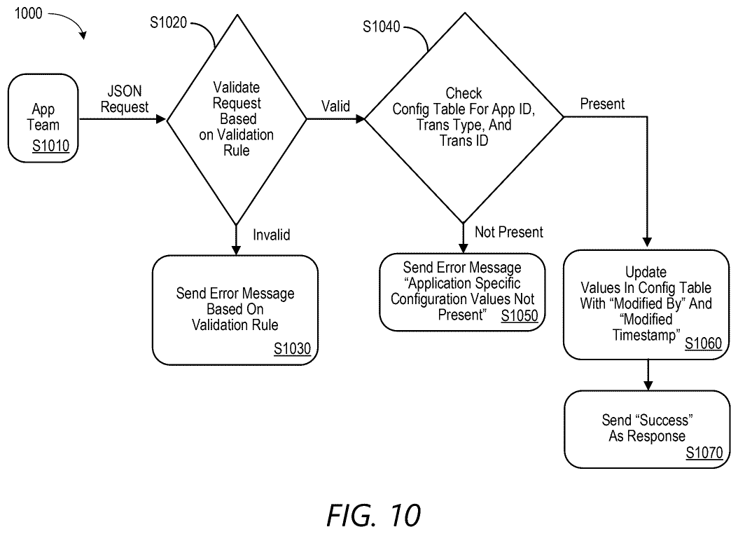

FIG. 10 is a configuration flow 1000 according to some embodiments. At S1010, an application team sends a JSON request that might include, for example, an application identifier, a transaction type, a transaction identifier type, a time duration type, a time duration, a threshold, a block period type, a block period, a “disable” flag, a “requested by identifier, and/or an optional action. The action might indicate, for example, that the update should be used to update any values based on the application identifier, the transaction type, and the transaction identifier type in the request. At S1020, the framework evaluates the request based on a validation rule. If the validation fails, an error message is returned at S1030.

If the validation succeeds, at S1040 the framework checks the configuration table for the application identifier, transaction type, and transaction identifier type. If these values are not present in the table, an error message is returned at S1050. If these values are present in the table, the framework updates the table (optionally adding a “modified by” and timestamp entry) at S1060 and a success message is returned at S1070.

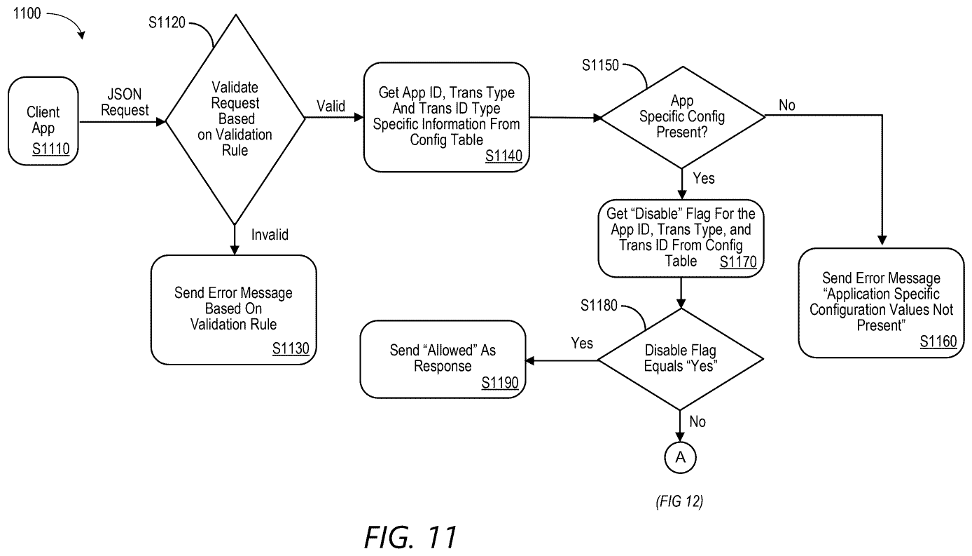

FIGS. 11 through 13 are a transaction check request flow in accordance with some embodiments. In FIG. 11, a JSON request is initially sent from a client application to the framework at S1110. The request may include, for example, an application identifier, a transaction type (e.g., a price quote, a search, etc.), a transaction identifier type (e.g., an IP address), and/or a transaction identifier (e.g., the actual values of the IP address). At S1120, the framework evaluates the request based on a validation rule. If the validation fails, an error message is returned at S1130.

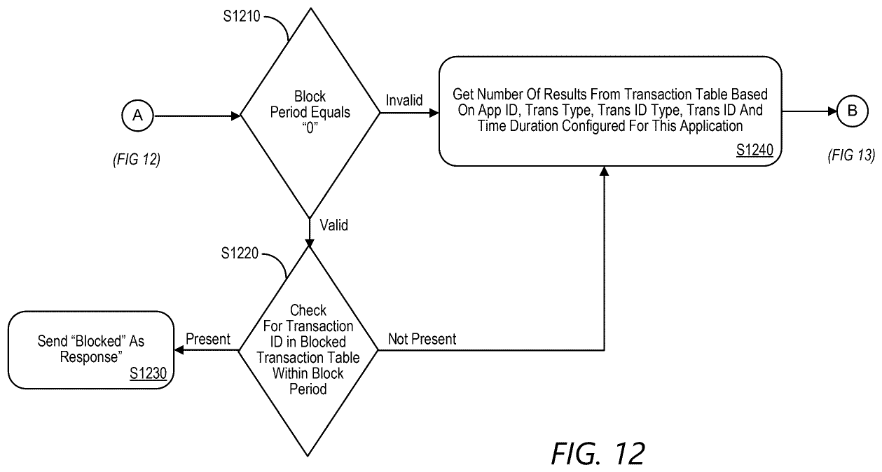

If the validation succeeds, at S1140 the framework obtains the application identifier, transaction type, and transaction identifier type specific information from the configuration table (e.g., a threshold limit for “APP-123,” “price quote,” and IP address). If that information is not in table at S1150, then an error message is returned as a reply at S1160. If that information is in table at S1150 and equals “yes” at S1170, then “allowed” is sent as a response at S1180. If the “disable” flag is “no” at S1170, the process continues at (A) in FIG. 12.

In FIG. 12, the framework determines if the block period in the configuration table is “0” at S1210. Note that the framework may fetch details from the transaction and blocked transactions table based on: (1) the created timestamp in the transaction table; and (2) the time duration type and time duration in the configuration table. For example, the time duration type might equal “hour” and the created timestamp may be ≤the current time−time duration. As another example, the time duration type might equal “calendar day” and the date of the created timestamp may be ≤today's date−(time duration−1). Moreover, the time duration value may include the current day when the time duration type is configured as “calendar day.” For example, if time duration equals “1” that would indicate “today” while a time duration of “2” would indicate “today or yesterday.”

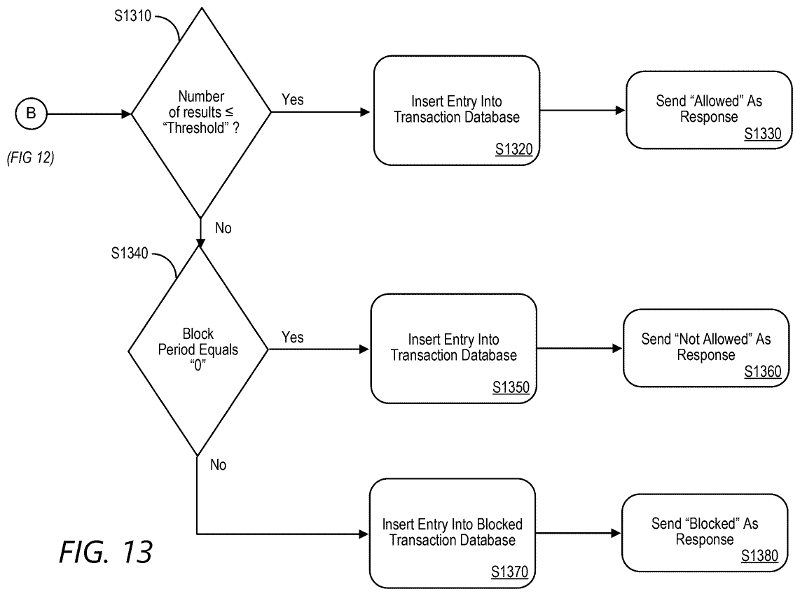

If the block period in the configuration table is “0” at S1210, then the framework checks for the transaction identifier (within the block period) in the blocked transaction table at S1220. If the transaction identifier is in the blocked transaction table (within the block period) at S1220, then a “blocked” response is returned at S1230. If the block period in the configuration table is not “0” at S1210 or the transaction identifier is not in the blocked transaction table (within the block period) at S1220, then the framework obtains the number of results in the transaction table based on the application identifier, transaction type, transaction identifier type, transaction identifier, and time duration for this application at S1240 and the process continues at (B) in FIG. 13.

In FIG. 13, if the number of results is not ≤to the threshold at S1310, then an entry is inserted into the transaction database at S1320 and an “allowed” response is returned to the consuming application at S1330. If the number of results is ≤to the threshold at S1310, then it is determined if the blocked period equals “0” at S1340. If the blocked period equals “0” at S1340, then an entry is inserted into the transaction database at S1350 and a “not allowed” response is returned to the consuming application at S1360. If the blocked period does not equal “0” at S1340, then an entry is inserted into the blocked transaction database at S1370 and a “blocked” response is returned to the consuming application at S1380.

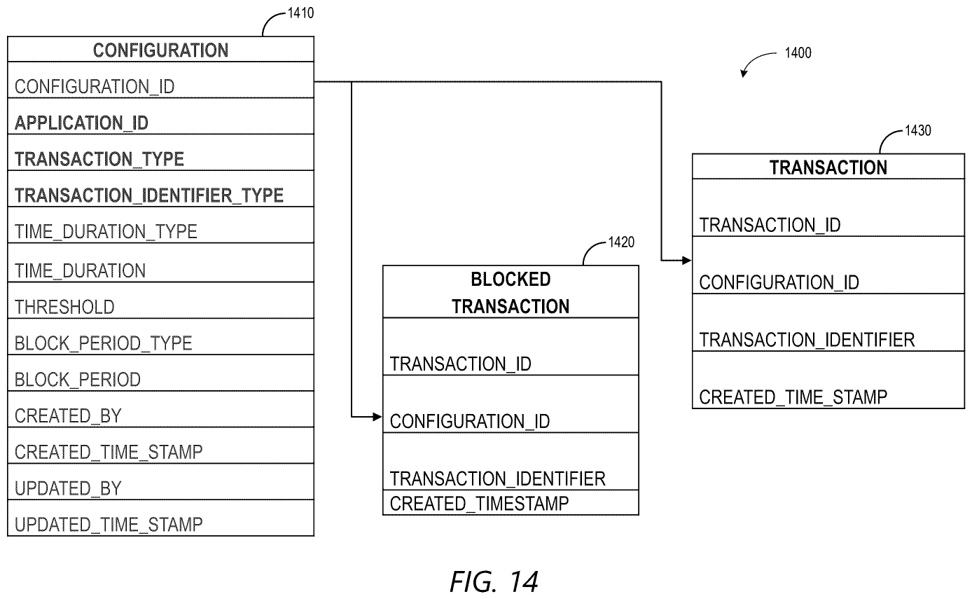

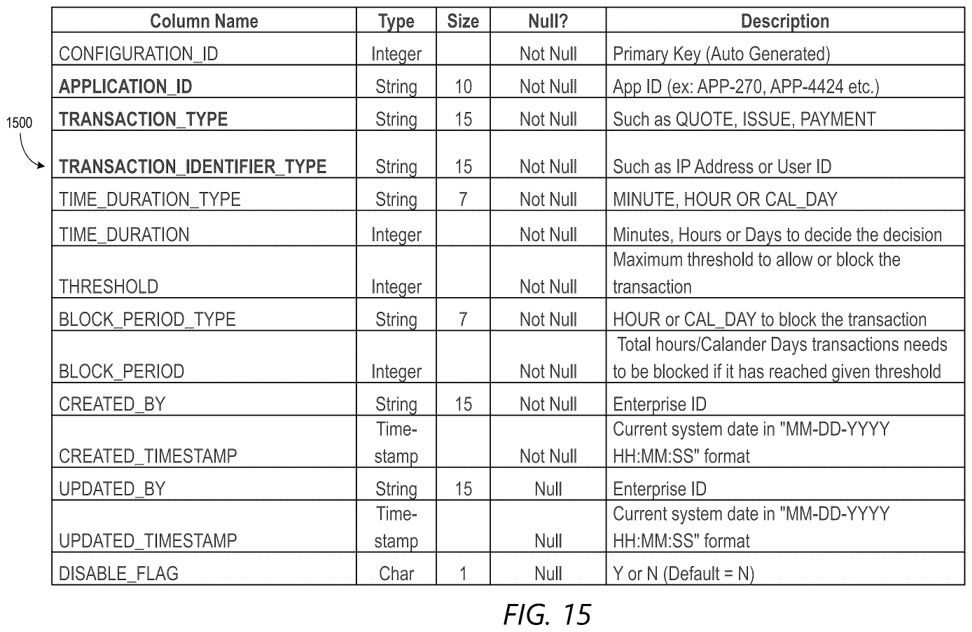

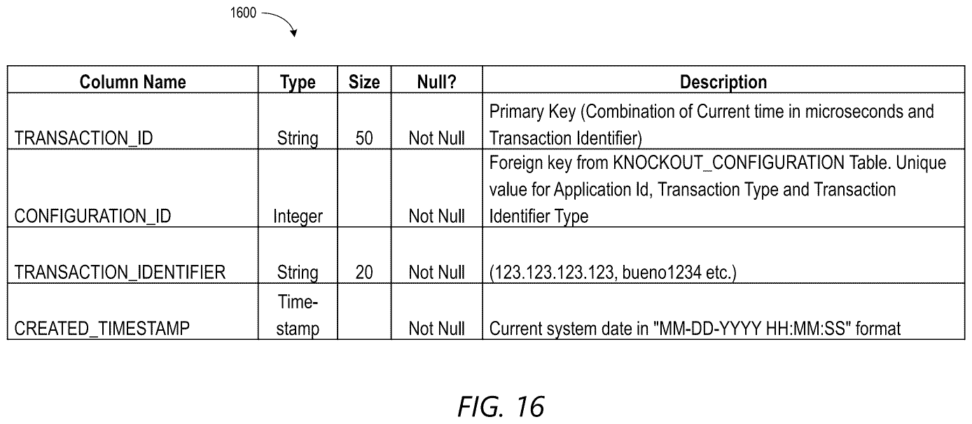

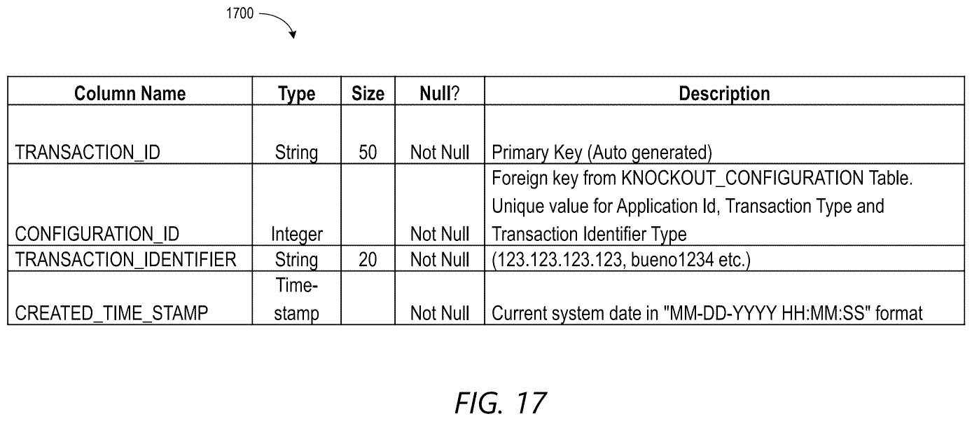

FIG. 14 illustrates relationships 1400 between tables according to some embodiments. A configuration identifies in a configuration table 1410 acts as a Primary Key (“PK”) that maps it to a Foreign Key (“FK”) in a blocked transaction table 1420 and a transaction table 1430. FIG. 15 is a configuration table design 1500 in accordance with some embodiments. FIG. 16 shows transaction table details 1600 according to some embodiments. FIG. 17 shows blocked transaction table details 1700 in accordance with some embodiments.

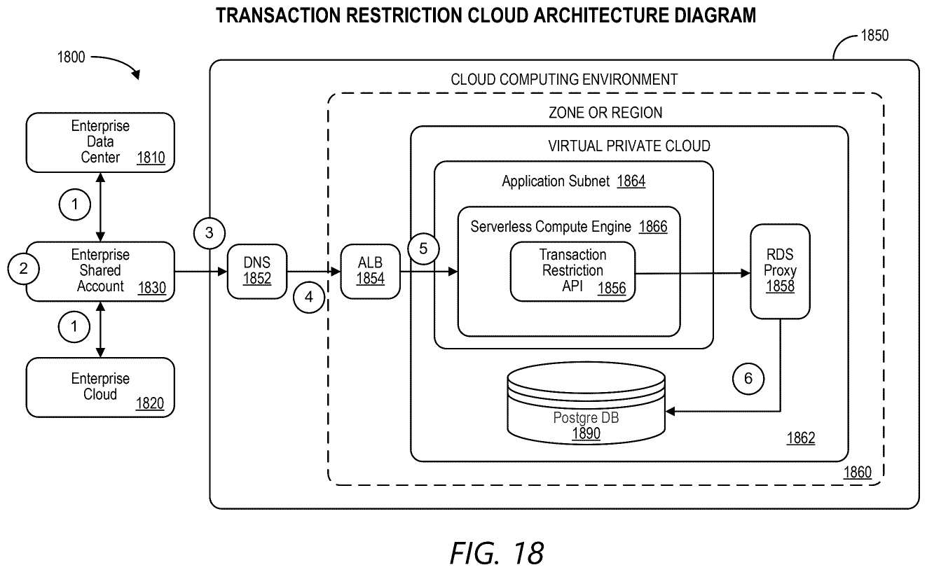

FIG. 18 is a transaction restriction cloud architecture 1800 according to some embodiments. At (1), an enterprise data center 1810 (e.g., on-premises) and an enterprise cloud communicate 1820 with a cloud computing environment 1850 via an enterprise shared account 1830 by calling an Application Policy Infrastructure Controller (“APIC”) endpoint from a service layer backend with a client identifier and a client secret. At (2), the enterprise shared account 1830 authenticates the request using APIC with the client identifier and the client secret. After successful authentication, at (3) and (4) information is sent to an Application Load Balancer (“ALB”) 1854 executing in a zone or region 1860 (e.g., “Eastern USA”) of the cloud computing environment 1850 via a Domain Name System (“DNS”) service 1852. The ALB 1854 directs the request to a serverless compute engine 1866 of an application subnet 1864 in a virtual private cloud 1862 at (5). A transaction restriction API can then access tables (e.g., a configuration table, transaction table, etc.) in a Postgre database 1890 through a Relational Database Service (“RDS”) proxy 1858 at (6).

In this way, embodiments may implement a transaction restriction API to provide a modularized solution letting applications limit, control, and block any exploitation of services by malicious actors. The applications can prevent a sudden surge of usages by defining threshold limits for various services. Moreover, embodiments may provide functionalities that allow, deny, or even block a specific user from accessing an application for a specific amount of time based on the defined threshold. The consuming application calls the transaction restriction API to perform the necessary checks and get a decision to allow or block a transaction as response. The API can make decisions based on unique identifiers (e.g., application identifier, transaction type, and transaction identifier) with the capability to validate and respond with different responses to the consuming application based on the configured threshold, time duration, and block period.

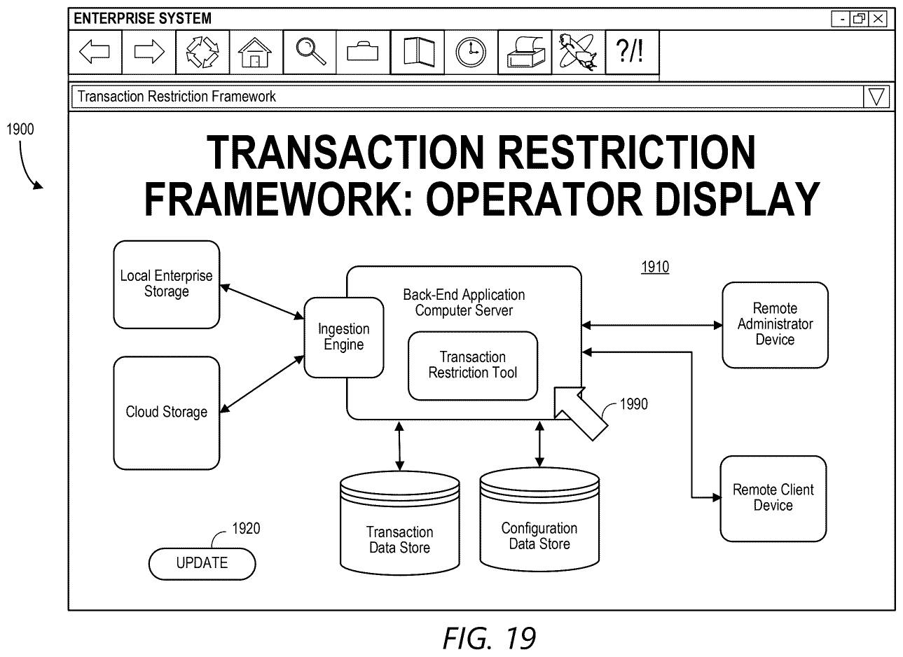

The operation of an enterprise transaction restriction framework may be controlled via a Graphical User Interface (“GUI”). For example, FIG. 19 is an enterprise transaction restriction framework operator or administrator display 1900 including graphical representations of elements of such a tool 1910 according to some embodiments. Selection of a portion or element of the display 1900 via a touchscreen or pointer 1990 might result in the presentation of additional information about that portion or element (e.g., a popup window presenting data mappings, transaction thresholds and configurations, etc.) or let an operator or administrator enter or annotate additional information about transaction restrictions (e.g., based on changes to application configurations, prior restriction results, etc.). An “Update” icon 1920 might let the administrator save updates and changes to the tool 1910.

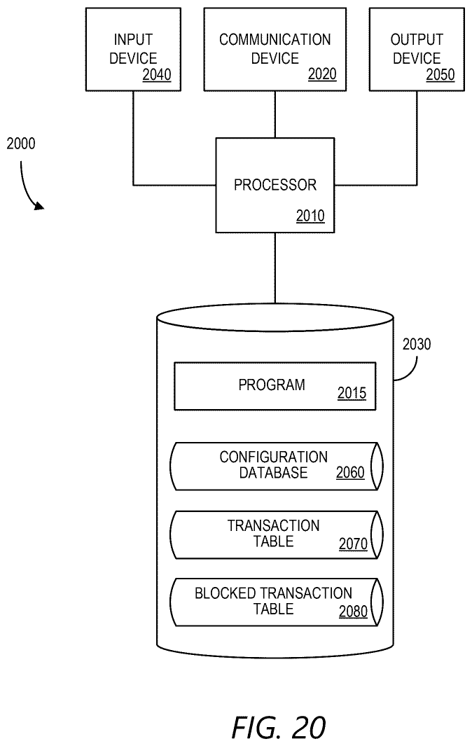

The embodiments described herein may be implemented using any number of different hardware configurations. For example, FIG. 20 illustrates an apparatus 2000 that may be, for example, associated with the enterprise transaction restriction system 100 described with respect to FIG. 1 (or any other system described herein). The apparatus 2000 comprises a processor 2010, such as one or more commercially available Central Processing Units (“CPUs”) in the form of one-chip microprocessors, coupled to a communication device 2020 configured to communicate via a communication network (not shown in FIG. 20). The communication device 2020 may be used to communicate, for example, with one or more remote cloud or on-premises systems, administrators, application developers, enterprise customers or clients, and/or other communication devices (e.g., PCs and smartphones). Note that communications exchanged via the communication device 2020 may utilize security features, such as those between a public internet user and an internal network of an insurance company and/or an enterprise. The security features might be associated with, for example, web servers, firewalls, and/or PCI infrastructure. The apparatus 2000 further includes an input device 2040 (e.g., a mouse and/or keyboard to enter information about transaction restrictions, application configurations, etc.) and an output device 2050 (e.g., to output reports regarding transaction restrictions, recommendations, alerts, etc.).

The processor 2010 also communicates with a storage device 2030. The storage device 2030 may comprise any appropriate information storage device, including combinations of magnetic storage devices (e.g., a hard disk drive), optical storage devices, mobile telephones, and/or semiconductor memory devices. The storage device 2030 stores a program 2015 and/or a transaction restriction tool or application for controlling the processor 2010. The processor 2010 performs instructions of the program 2015 and thereby operates in accordance with any of the embodiments described herein. For example, the processor 2010 may receive a transaction check request, including an application identifier and a transaction identifier, from a consuming application via API. The processor 2010 can then access the configuration data store to determine a transaction restriction associated with the consuming application. A transaction check can then be automatically performed by the processor 2010 based on the transaction restriction and transaction identifier, and a response to the consuming application indicating a result of the transaction check may be transmitted.

The program 2015 may be stored in a compressed, uncompiled and/or encrypted format. The program 2015 may furthermore include other program elements, such as an operating system, a database management system, and/or device drivers used by the processor 2010 to interface with peripheral devices.

As used herein, information may be “received” by or “transmitted” to, for example: (i) the apparatus 2000 from another device; or (ii) a software application or module within the apparatus 2000 from another software application, module, or any other source.

In some embodiments (such as shown in FIG. 20), the storage device 2030 further includes a configuration database 2060, a transaction table 2070, and a blocked transaction table 2080. Note that the databases described herein are only examples, and additional and/or different information may be stored therein. Moreover, various databases might be split or combined in accordance with any of the embodiments described herein. For example, the transaction table 2070 and the blocked transaction table 2080 might be combined and/or linked to each other within the program 2015.

Thus, embodiments may avoid application downtime and ensure application security by blocking repeated requests from malicious actors. Embodiments may save application development team efforts to write application specific logic to make such decisions. Instead, they can just configure and call the API and get an appropriate decision. Embodiments may save infrastructure cost by maintaining all applications transaction details in one database. Such a centralized solution to take transaction restriction actions may be used across all of the applications within an enterprise because the approach can be platform and technology independent.

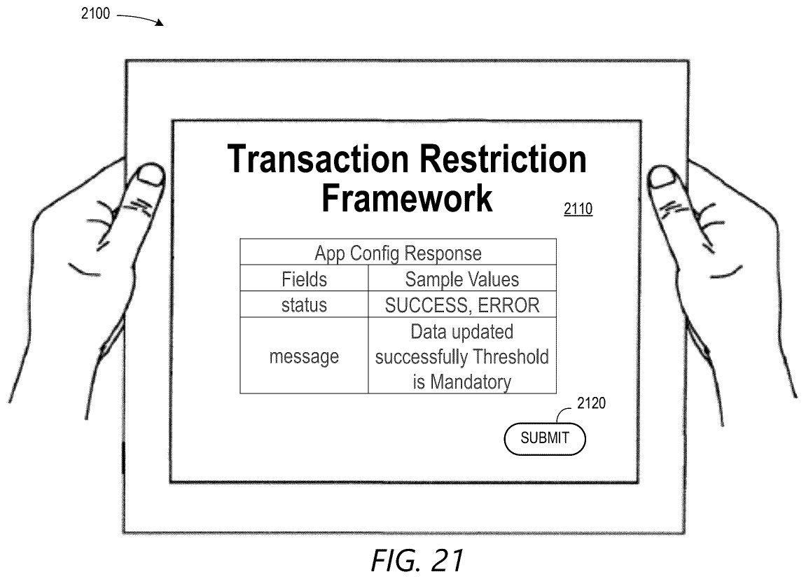

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of enterprises, embodiments may instead be associated with other types of financial enterprises, educational institutions, organizations, etc. instead. FIG. 21 illustrates a handheld tablet 2100 in accordance with some embodiments. A transaction restriction framework display 2110 might, for example, let an operator review, modify or implement application configurations, requests, and responses associated with an enterprise via a “Submit” icon 2120.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. A transaction restriction system for an enterprise, comprising:
(a) a configuration data store that contains electronic records associated with enterprise applications including, for each application, at least one application identifier and associated transaction restriction; and
(b) a cloud-based transaction restriction tool, coupled to the configuration data store, including:
a computer processor, and
a computer memory coupled to the computer processor and storing instructions that, when executed by the computer processor, cause a back-end application computer server associated with the transaction restriction tool to:
receive a transaction check request, including an application identifier and a transaction identifier, from a consuming application of the enterprise via an Application Programming Interface (“API”),
access the configuration data store to determine a transaction restriction associated with the consuming application,
automatically perform a transaction check based on the transaction restriction and transaction identifier, and
transmit a response to the consuming application indicating a result of the transaction check.

2. The system of claim 1, wherein the transaction restriction includes at least one of: (i) preventing more than a threshold number of transactions from a communication address, (ii) preventing more than a threshold number of transactions from a communication address within a predetermined period of time, and (iii) preventing more than a threshold number of transactions from a user within a predetermined period of time.

3. The system of claim 1, wherein electronic records in the configuration data store further include, for each application, at least one of: (i) a transaction type, (ii) a transaction identifier type, (iii) a time duration type, (iv) a time duration, (v) a threshold, (vi) a block period type, (vi) a block period, (vii) a disable flag, (viii) and a requested by identifier.

4. The system of claim 1, wherein the transaction check request further includes at least one of: (i) a transaction type, and (ii) a transaction identifier type.

5. The system of claim 1, wherein the transaction identifier includes at least one of: (i) a communication address, (ii) an Internet Protocol (“IP”) address, (iii) a user identifier, (iv) a state, and (v) a session identifier.

6. The system of claim 1, wherein the result of the transaction check indicates that the transaction is “allowed” when a number of transactions is within a threshold limit in a given time duration.

7. The system of claim 1, wherein the result of the transaction check indicates that the transaction is “not allowed” when a number of transactions exceeds a threshold limit and no blocking period is set.

8. The system of claim 1, wherein the result of the transaction check indicates that the transaction is “blocked” when a number of transactions exceeds a threshold within a blocking period.

9. The system of claim 1, wherein the transaction restriction tool is able to configure a time duration in accordance with minutes, hours, calendar days, or business days.

10. The system of claim 1, wherein the transaction restriction tool is able to enable or disable transaction checks for specific configurations.

11. The system of claim 1, wherein the transaction restriction tool is able to whitelist transactions.

12. The system of claim 1, wherein the transaction restriction tool is able to capture an incoming request from the consuming application in one place and perform the transaction request check in another place or do both at same time.

13. The system of claim 1, wherein a configuration request received from an administrator includes at least one of: (i) an application identifier, (ii) a transaction type, (iii) a transaction identifier type, (iv) a time duration type, (v) a time duration, (vi) a threshold, (vii) a block period type, (viii) a block period, (ix) a disable flag, (x) a requested by identifier, (xi) and (xii) an action.

14. The system of claim 13, wherein a response to the configuration request includes at least one of: (i) a “success” status, (ii) an “error” status, and (iii) a message.

15. The system of claim 1, further comprising transaction and blocked transaction data stores.

16. A transaction restriction method for an enterprise, comprising:
receiving, by a back-end application computer server associated with a transaction restriction tool, a transaction check request, including an application identifier and a transaction identifier, from a consuming application of the enterprise via an Application Programming Interface (“API”);
accessing a configuration data store to determine a transaction restriction associated with the consuming application, wherein the configuration data store contains electronic records associated with enterprise applications including, for each application, at least one application identifier and associated transaction restriction;
automatically performing a transaction check based on the transaction restriction and transaction identifier; and
transmitting a response to the consuming application indicating a result of the transaction check.

17. The method of claim 16, wherein the transaction restriction includes at least one of: (i) preventing more than a threshold number of transactions from a communication address, (ii) preventing more than a threshold number of transactions from a communication address within a predetermined period of time, and (iii) preventing more than a threshold number of transactions from a user within a predetermined period of time.

18. The method of claim 16, wherein electronic records in the configuration data store further include, for each application, at least one of: (i) a transaction type, (ii) a transaction identifier type, (iii) a time duration type, (iv) a time duration, (v) a threshold, (vi) a block period type, (vi) a block period, (vii) a disable flag, (viii) and a requested by identifier.

19. A non-transitory, computer-readable medium storing instructions, that, when executed by a processor, cause the processor to perform a transaction restriction method for an enterprise, the method comprising:
receiving, by a back-end application computer server associated with a transaction restriction tool, a transaction check request, including an application identifier and a transaction identifier, from a consuming application of the enterprise via an Application Programming Interface (“API”);
accessing a configuration data store to determine a transaction restriction associated with the consuming application, wherein the configuration data store contains electronic records associated with enterprise applications including, for each application, at least one application identifier and associated transaction restriction;
automatically performing a transaction check based on the transaction restriction and transaction identifier; and
transmitting a response to the consuming application indicating a result of the transaction check.

20. The medium of claim 19, wherein the result of the transaction check indicates that the transaction is “allowed” when a number of transactions is within a threshold limit in a given time duration.

21. The medium of claim 19, wherein the result of the transaction check indicates that the transaction is “not allowed” when a number of transactions exceeds a threshold limit and no blocking period is set.

22. The medium of claim 19, wherein the result of the transaction check indicates that the transaction is “blocked” when a number of transactions exceeds a threshold within a blocking period.
